(19) United States
(12) Patent Application Publication
(10) Pub. No.: US 2017/0181920 A1
(43) Pub. Date: Jun. 29, 2017

(54) MASSAGE MACHINE

(71) Applicant: FAMILY INADA CO., LTD., Osaka (JP)

(72) Inventor: Yuichi Okamoto, Tottori (JP)

(21) Appl. No.: 15/390,228

(22) Filed: Dec. 23, 2016

(30) Foreign Application Priority Data
Dec. 24, 2015 (JP) 2015-251302

(51) Int. Cl. A61H 9/00; A47C 7/38; A47C 31/12; A47C 1/00

(52) U.S. Cl. CPC A61H 9/0078; A47C 1/00; A47C 7/38; A47C 7/383; A47C 31/126; A61H 2205/081

(57) ABSTRACT

A massage machine includes a backrest portion that supports a body of a person to be treated, a pillow portion that supports a head of the person to be treated, and a pillow support portion that supports the pillow portion. The pillow portion is configured to be movable in a body height direction with respect to the backrest portion, and the pillow support portion supports the pillow portion from the back side while positioning the pillow portion above an upper end of the backrest portion.

### RELATED APPLICATION

This application claims the benefit of Japanese Patent Application No. 2015-251302 filed on Dec. 24, 2015, the contents of which, including the specification, claims and drawings, are incorporated herein by reference in their entirety.

### FIELD OF THE INVENTION

The present invention relates to a massage machine. More specifically, the invention relates to a massage machine capable of moving a pillow portion to a height suitable for a body height (sitting height) without changing a contact surface between a head of a person to be treated and the pillow portion.

### BACKGROUND ART

In the related art, a massage machine with a head portion that is positioned above a backrest portion and is freely rotatable is known. This massage machine can adjust a degree of contact between a treatment element and a site to be treated by adjusting a position of the head portion.

### SUMMARY OF THE INVENTION

A massage machine according to the invention includes a backrest portion that supports a body of a person to be treated, a pillow portion that supports a head of the person to be treated, and a pillow support portion that supports the pillow portion. The pillow portion is configured to be movable in a body height direction with respect to the backrest portion, and the pillow support portion supports the pillow portion from the back side while positioning the pillow portion above an upper end of the backrest portion.

### BRIEF DESCRIPTION OF THE DRAWINGS

FIG. 1 is a perspective view of a massage machine according to an embodiment of the invention.

FIG. 2A is a perspective view of a support portion, FIG. 2B is a front view of the support portion, and FIG. 2C is a side view of the support portion.

FIGS. 3A and 3B are diagrams illustrating that a pillow support portion is configured of an air cell, where FIG. 3A is a side view illustrating a state in which a pillow portion is positioned below an upper end of a backrest portion and FIG. 3B is a side view illustrating a state in which the pillow portion is positioned above the upper end of the backrest portion.

FIGS. 4A and 4B are diagrams illustrating that a top surface of the backrest portion is moved by the pillow support portion, where FIG. 4A is a side view illustrating a state before the moving and FIG. 4B is a side view illustrating a state after the moving.

FIGS. 5A and 5B are diagrams illustrating that the pillow support portion is configured of a stretching mechanism, where FIG. 5A is a side view illustrating a contracting state and FIG. 5B is a side view illustrating an extending state.

FIGS. 6A and 6B are enlarged views of the stretching mechanism, where FIG. 6A is a perspective view illustrating the contracting state and FIG. 6B is a perspective view illustrating the extending state.

FIGS. 7A and 7B are diagrams illustrating that the pillow support portion is configured to be freely attached and detached, where FIG. 7A is a side view illustrating an attached state and FIG. 7B is a side view illustrating a detached state.

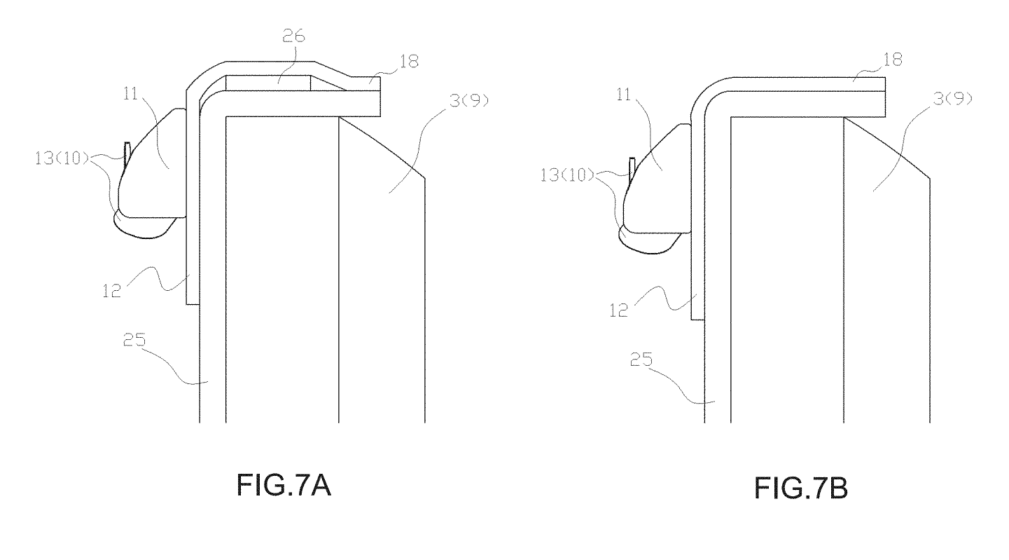

FIGS. 8A and 8B are diagrams illustrating a state in which the pillow portion has moved to a height suitable for a body height of a person to be treated, where FIG. 8A is a side view illustrating a person to be treated who is short and FIG. 8B is a side view illustrating a person to be treated who is tall.

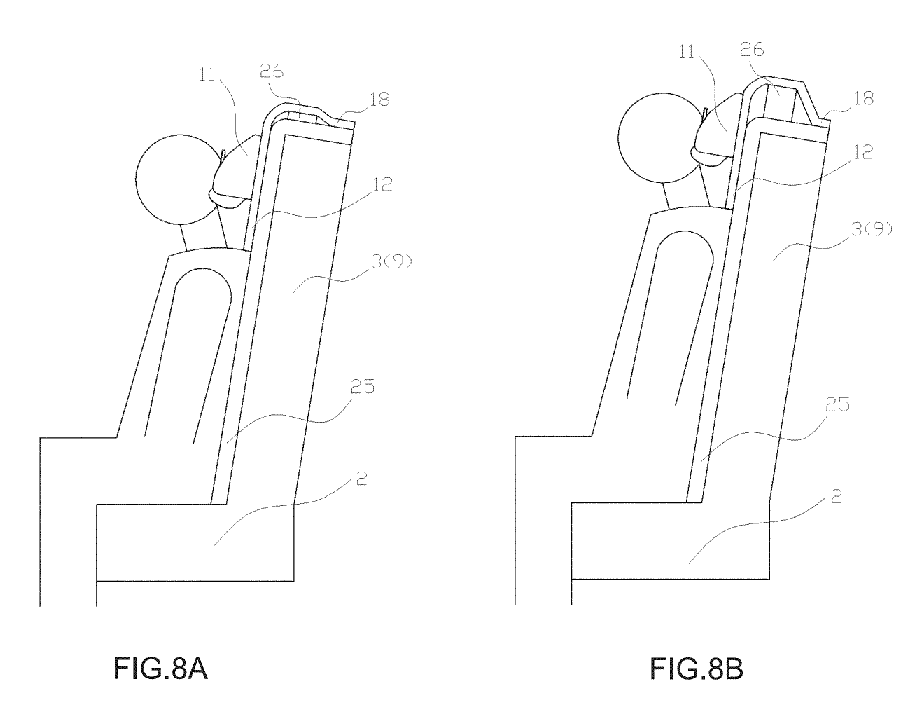

FIGS. 9A and 9B are diagrams illustrating a state in which the pillow portion moves in accordance with a treatment operation of a treatment mechanism, where Fig. 9A is a side view illustrating a state before the treatment mechanism is positioned at the neck and FIG. 9B is a side view illustrating a state in which the treatment mechanism is positioned at a neck.

### DETAILED DESCRIPTION OF THE INVENTION

### Overall Configuration

Hereinafter, description will be given of an overall configuration of a massage machine according to an embodiment of the invention.

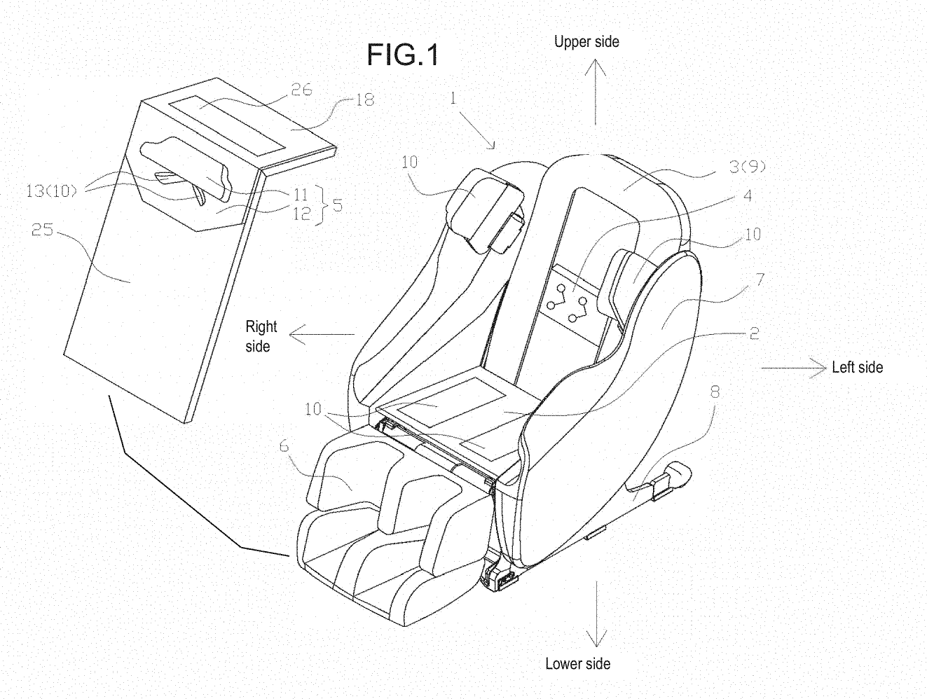

It is assumed that concepts of directions used in the following description coincide with concepts of directions when viewed from a person to be treated who is sitting on a massage machine 1 in a standing state as illustrated in FIG. 1, the left arm side is represented as a “left side”, the right arm side is represented as a “right side”, the head side is represented as an “upper side”, the lower back side is represented as a “lower side”, and otherwise, description will appropriately be given.

### Overall Configuration of Massage Machine

As illustrated in FIG. 1, the massage machine 1 according to the embodiment mainly includes a seat portion 2 on which the person to be treated sits, a backrest portion 3, which is provided at a back portion of the seat portion 2 so as to be able to be reclined, against which the person to be treated leans, a treatment mechanism 4 that is provided inside the backrest portion 3 so as to be freely lifted and lowered, a pillow portion 5 that is provided at the backrest portion 3 and supports a head of the person to be treated, a footrest 6 that is provided at a front portion of the seat portion 2 so as to be able to vertically swing and supports legs and feet of the person to be treated, armrest portions 7, which are provided on both right and left sides of the seat portion 2, on which the person to be treated places their arms, and a leg frame 8 that supports the seat portion 2 and is installed on a floor surface. In addition, a treatment portion 10 for treating the person to be treated is provided at each body support portion 9, such as the seat portion 2 and the backrest portion 3, which supports the body of the person to be treated.

### Configuration of Pillow Portion

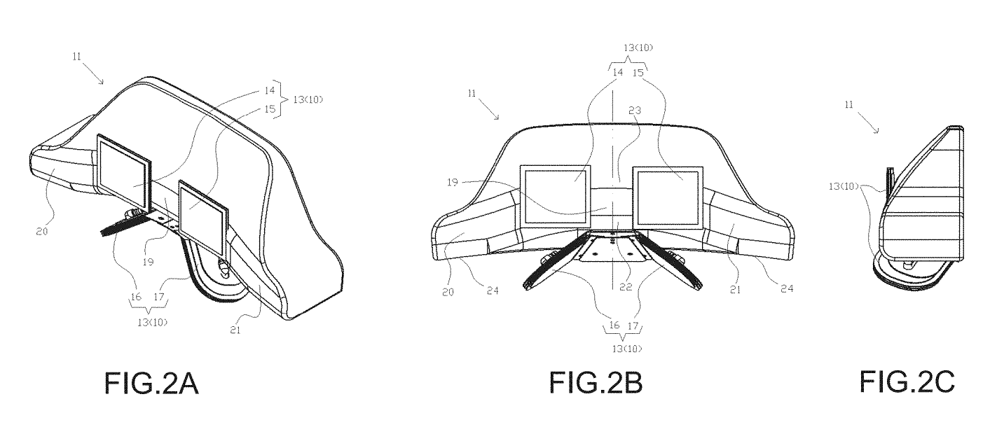

As illustrated in FIGS. 1 to 5B, the massage machine 1 has the pillow portion 5 for supporting the head of the person to be treated, is configured mainly of a support portion 11 that can support at least the head of the person to be treated and is covered with a cover member (not illustrated), a support portion pad 12 to which the support portion 11 is attached, and an air cell 13 that is provided at the support portion 11 as a treatment portion that can press a treatment target portion of the person to be treated, and is attached to the backrest portion 3 via a support portion pad attachment portion 18.

Specifically, the support portion 11 is configured of a center portion 19 that is positioned at the center thereof in the horizontal direction and supports the neck and the head and a pair of right and left side portions 20 and 21 that are positioned above shoulders on both the right and left sides of the center portion 19, and the center portion 19 and the both side portions 20 and 21 are integrally configured so as to continue in the horizontal direction.

The center portion 19 has a lower portion support surface 22 that can support a lower portion of the head and/or the neck, an upper portion support surface 23 that can support the upper portion of the head, and a facing surface 24 that is provided so as to stand from a lower end of the lower portion support surface 22 toward the back side and faces upper surfaces of the shoulders. The upper portion support surface 23 is configured such that at least a part of the upper portion support surface 23 is positioned on the back side beyond the lower portion support surface 22. Specifically, the upper portion support surface 23 is configured to continue from the upper end of the lower portion support surface 22 toward the upper side and incline toward the back side from the lower side toward the upper side. The upper portion support surface 23 is elongated in the horizontal direction as a whole and is formed in a substantially trapezoidal shape when viewed from the front side.

The center portion 19 includes first air cells 14 and 15 provided at the lower portion support surface 22 to press the head from the back side toward the front side, and includes second air cells 16 and 17 provided at the facing surface 24 to press the neck from the upper side or outer side. Specifically, the first air cells 14 and 15 provided at the lower portion support surface 22 are configured to form a pair on the left and right sides while interposing the center line of the pillow portion 5 in the horizontal direction. The second air cells 16 and 17 provided at the facing surface 24 are configured to form a pair on the left and right sides while interposing the center line. The first air cells 14 and 15 and the second air cells 16 and 17 are configured to be able to independently expand and contract.

### Configuration of Support Portion Pad

The support portion 11 is attached to the support portion pad 12 that is made of leather with flexibility and is provided so as to extend in the vertical and horizontal directions. An attachment position of the support portion 11 may be an upper portion or a lower portion of the support portion pad 12. One end of the support portion pad 12 is attached to one end of the support portion pad attachment portion 18, and the other end of the support portion pad attachment portion 18 is attached to the backrest portion 3. The support portion pad attachment portion 18 may be configured to be freely attached to and detached from the backrest portion 3.

### Configuration of Pillow Support Portion

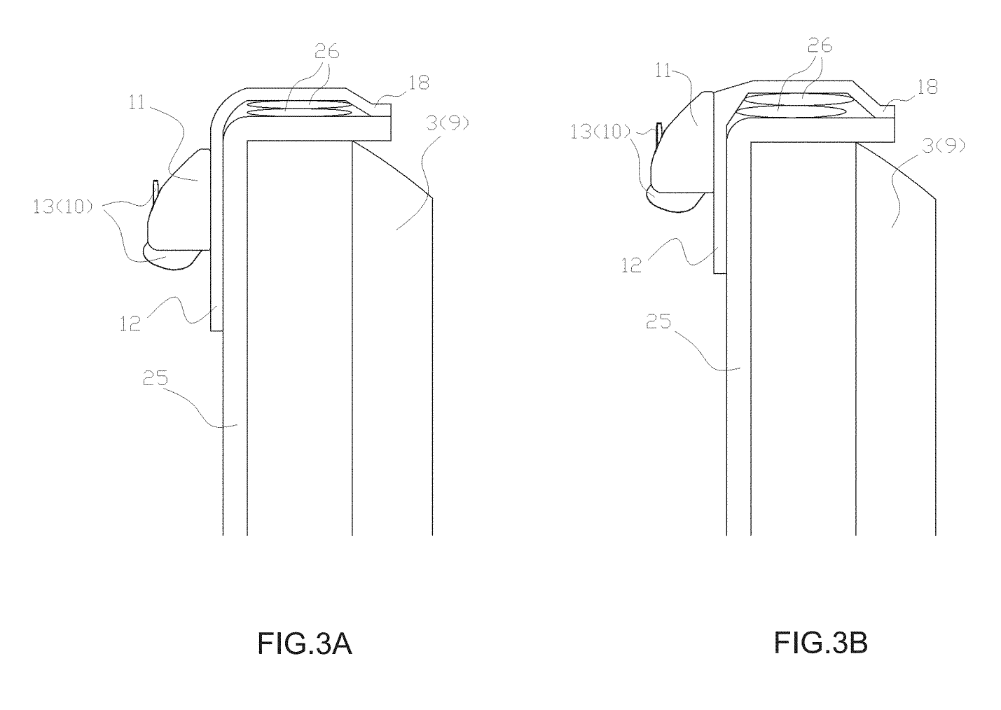

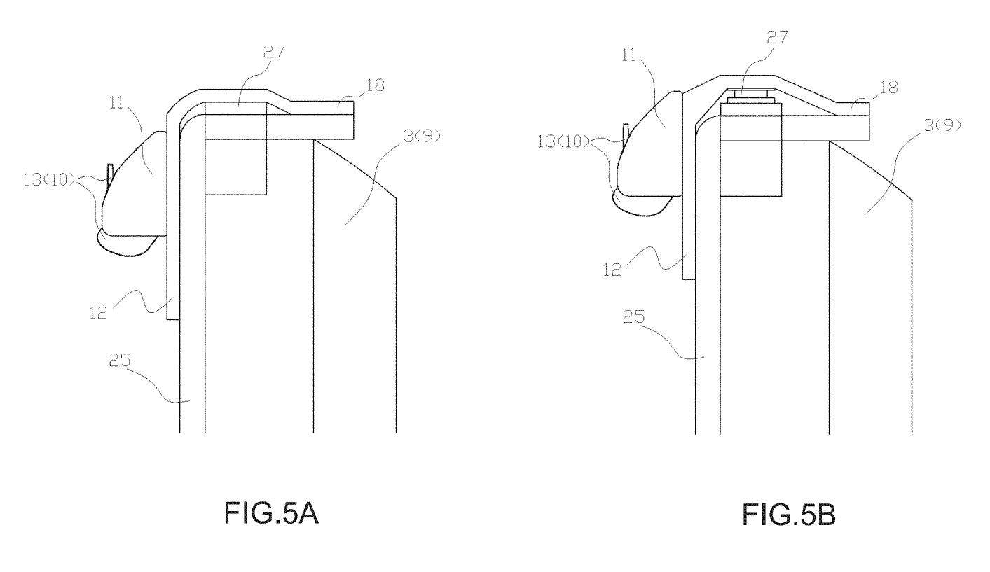

As illustrated in FIGS. 3A, 3B, 5A, and 5B, a pillow support portion 26 for moving the pillow portion 5 in the body height direction with respect to the backrest portion 3 is provided between the support portion pad 12 and a back pad 25, and the pillow support portion 26 supports the pillow portion 5 from the back side.

The pillow portion 5 is lifted from a back end of the support portion pad 12 as a base point by driving the pillow support portion 26, the pillow portion 5 can be supported from the back side by the support portion pad 12 and the pillow support portion 26 abutting each other, and at least a part of the pillow portion 5 can be positioned above the upper end of the backrest portion.

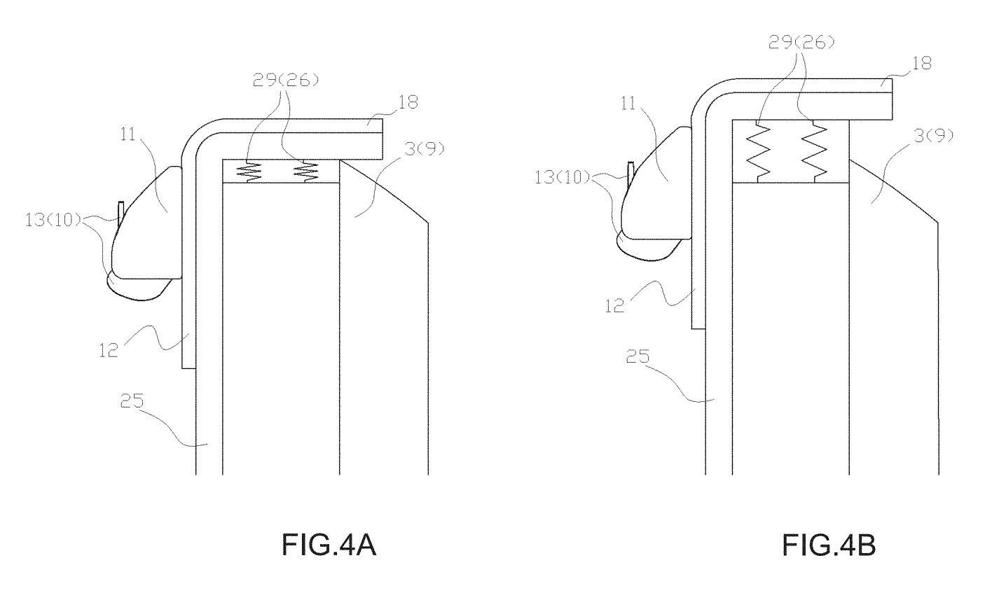

The pillow support portion 26 may be provided inside the backrest portion 3. As illustrated in FIGS. 4A and 4B, the pillow support portion 26 (a spring 29, for example) for moving the pillow portion 5 in the body height direction with respect to the backrest portion 3 is provided inside the backrest portion, and the pillow support portion 26 supports the pillow portion 5 from the lower side. Then, the entire upper surface of the backrest portion 3 vertically moves by using the pillow support portion 26, the entire pillow portion 5 is lifted, and at least a part of the pillow portion 5 can be positioned above the upper end of the backrest portion.

The pillow support portion 26 may have any configuration as long as the pillow portion 5 is supported from the back or lower side and at least a part of the pillow portion 5 can be positioned above the end portion of the backrest portion, and may have any of a mechanical configuration or an air cell configuration.

The pillow support portion 26 may be positioned at the top surface of the backrest portion 3 or the top surface of the back pad 25 provided at the backrest portion. Since it is not necessary to separately secure a space for providing the pillow support portion 26 in such a configuration, it is possible to adjust the height suitable for the body height (siting height) of the person to be treated without requiring a complicated structure and changing a contact surface between the head of the person to be treated and the pillow portion 5.

The pillow support portion 26 may be positioned between the back pad 25 and the pillow portion 5. Since there is no need to separately secure the space for providing the pillow support portion 26 by positioning the pillow support portion 26 between the back pad 25 and the pillow portion 5, it is possible to adjust the height suitable for the body height (sitting height) of the person to be treated without requiring a complicated structure and changing the contact surface between the head of the person to be treated and the pillow portion 5.

As illustrated in FIGS. 3A and 3B, the pillow support portion 26 may be configured of an air cell. By the pillow support portion 26 configured of the air cell, it is possible to smoothly adjust the height suitable for the body height (sitting height) of the person to be treated at low cost without requiring a complicated structure and changing the contact surface between the head of the person to be treated and the pillow portion 5.

### Stretching Mechanism

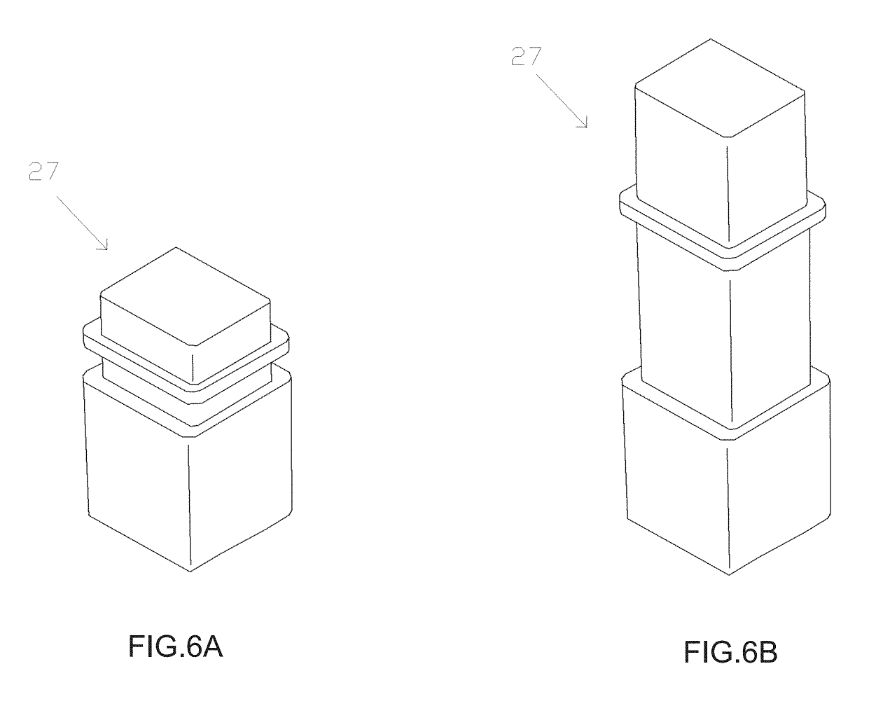

As illustrated in FIGS. 5A, 5B, 6A, and 6B, the pillow support portion 26 may be configured of a stretching mechanism 27. By the pillow support portion 26 configured of the stretching mechanism 27, it is possible to smoothly adjust the height suitable for the body height (sitting height) of the person to be treated.

The stretching mechanism 27 is configured of a substantially square telescopic mechanism that stretches in the vertical direction and can adjust the height of the pillow portion 5 in three levels. Level adjustment may be no-level adjustment instead of the three-level adjustment. Although not illustrated in the drawings, it is possible to hold the pillow portion 5 at the height after the adjustment by providing a locking mechanism.

As illustrated in FIGS. 3A and 3B, the pillow support portion 26 is inserted below the support portion pad attachment portion 18 so as to be able to position at least a part of the pillow portion 5 above the upper end of the backrest portion. The pillow support portion 26 may be configured to be able to freely attached and detached. By the pillow support portion 26 configured to be freely attached and detached, it is possible for the person to be treated themselves to manually select the pillow support portion 26 in accordance with the height suitable for the body height (sitting height) of the person to be treated without changing the contact surface between the head of the person to be treated and the pillow portion 5.

The massage machine 1 may include a detection unit 28 for detecting the body shape (a shoulder position, for example) of the person to be treated. The detection unit 28 is provided at the treatment mechanism 4, calculates a position of the neck of the person to be treated based on the shoulder position of the person to be treated, which has been detected by the detection unit 28, and makes it possible to automatically adjust the pillow portion 5 to the height suitable for the body height (sitting height) of the person to be treated by driving the pillow support portion 26. With such a configuration, it is possible to massage the neck of the person to be treated while using the pillow portion 5. Any detection unit such as a light sensor or a pressure sensitive sensor may be used as long as the detection unit can detect the body shape of the person to be treated.

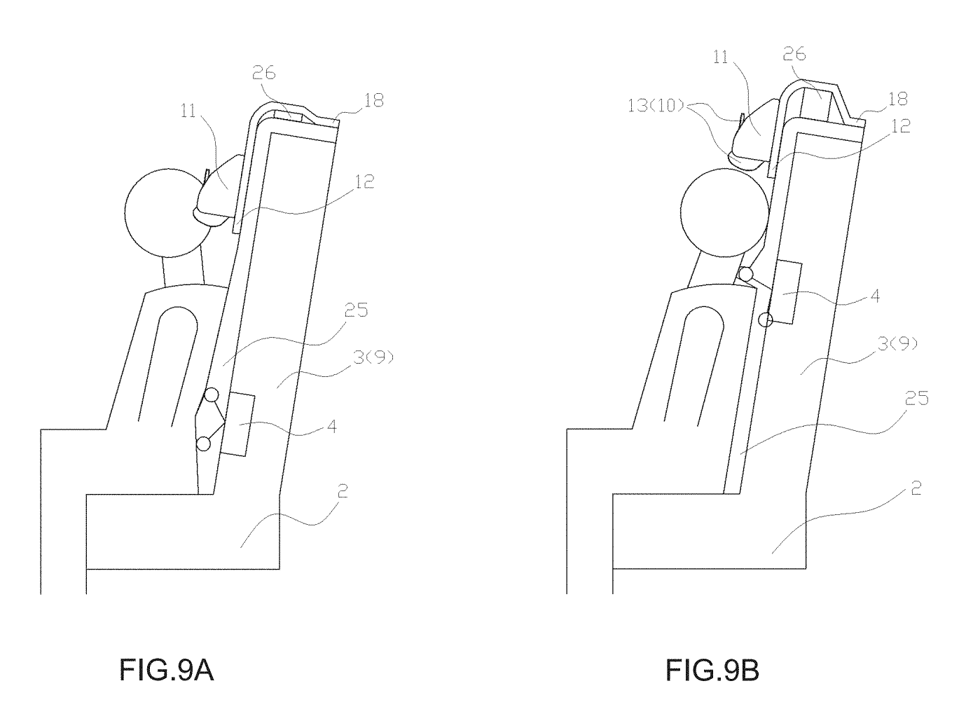

As illustrated in FIGS. 9A and 9B, the pillow support portion 26 may be driven in accordance with the treatment operation of the treatment mechanism 4. With such a configuration, it is possible to reliably massage the neck of the person to be treated without requiring any effort for manually moving the pillow portion 5 to a position at which the pillow portion 5 is not in contact with the head of the person to be treated in order to massage the neck of the person to be treated.

In sales sites such as electronics retail stores, the massage machine is used in a state where the pillow portion 5 is stripped off toward the back surface side of the backrest portion 3 in many cases. The pillow portion 5 may be brought into contact with a floor and may be contaminated if the massage machine is reclined in such a state. Also, since the massage machine is left in the state during the use even after the use, appearance deteriorates, and purchase motivation is damaged in some cases. However, the pillow support portion 26 can prevent the product from being contaminated, prevent the appearance from deteriorating, and prevent the purchase motivation from being damaged.

Also, a combination of the expansion and contraction operations of the first air cells 14 and 15 and the second air cells 16 and 17 provided at the pillow portion 5 and the treatment operation of the treatment mechanism 4 makes it possible to a variety of massage including stretching of the head or the neck by the pillow portion 5 and the massage by the treatment mechanism 4.

What is claimed is:

1. A massage machine comprising:
a backrest portion;
a pillow portion; and
a pillow support portion,
wherein the pillow portion is configured to be movable in a body height direction with respect to the backrest portion, and
wherein the pillow support portion supports the pillow portion from the back side while positioning the pillow portion above an upper end of the backrest portion.

2. The massage machine according to claim 1,
wherein the pillow support portion is positioned at a top surface of the backrest portion.

3. The massage machine according to claim 1,
wherein the pillow support portion is positioned between the backrest portion and the pillow portion.

4. The massage machine according to claim 1,
wherein the pillow support portion is configured of an air cell.

5. The massage machine according to claim 1,
wherein the pillow support portion is configured of a stretching mechanism.

6. The massage machine according to claim 1,
wherein the pillow support portion is configured to be freely attached and detached.

7. The massage machine according to claim 1, further comprising:
a detection unit that detects a body shape of a person to be treated,
wherein the pillow portion is able to be moved by driving the pillow support portion in accordance with the body shape of the person to be treated, which has been detected by the detection unit.

8. The massage machine according to claim 1, further comprising:
a treatment mechanism that treats a person to be treated,
wherein the pillow support portion is driven in accordance with a treatment operation of the treatment mechanism.
